(19) United States
(12) Patent Application Publication
(10) Pub. No.: US 2024/0331582 A1
(43) Pub. Date: Oct. 3, 2024

(54) SURFACE DECORATION DEVICE AND METHOD

(71) Applicant: Daniel Blanks, Brandon, MS (US)

(72) Inventor: Daniel Blanks, Brandon, MS (US)

(21) Appl. No.: 18/126,979

(22) Filed: Mar. 27, 2023

(51) Int. Cl. G09F 7/18; E04F 15/02

(52) U.S. Cl. CPC G09F 7/18; E04F 15/0215; G09F 2007/1852; G09F 2007/1873

(57) ABSTRACT

A surface decoration device and method for decorating a surface with sports related indicia includes a tile including a top surface, a bottom surface, and a perimeter edge. A sports related indicia is positioned on the top surface of the tile and displays indicia corresponding to a sports team. A fastener is mounted to the tile and fastens the tile to a floor surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to decorative tiles and more particularly pertains to a new decorative tile for decorating a surface with sports related indicia.

### (2) Description of Related Art Including Information Disclosed Under 37 CFR 1.97 and 1.98

The prior art relates to decorative tiles and includes a variety of decorative tiles being conterminous to each other when the decorative tiles are mounted to a surface. Known prior art does not include a decorative tile which has a sports related indicia thereon and is mountable to an existing surface.

### BRIEF SUMMARY OF THE INVENTION

An embodiment of the disclosure meets the needs presented above by generally comprising a tile including a top surface, a bottom surface, and a perimeter edge. A sports related indicia is positioned on the top surface of the tile and is configured for displaying indicia corresponding to a sports team. A fastener is mounted to the tile and is configured to fasten the tile to a floor surface.

Another embodiment of the disclosure comprises a method including the steps of providing a tile having a sports related indicia thereon. The tile includes a top surface, a bottom surface, and a perimeter edge. The sports related indicia is positioned on the top surface of the tile and is configured for displaying indicia corresponding to a sports team. A removable panel is removed from an adhesive layer of a bottom surface of the tile and the tile is fastened to a surface thereafter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of a surface decoration device and method according to an embodiment of the disclosure.

FIG. 2 is a bottom isometric view of an embodiment of the disclosure.

FIG. 3 is a top isometric view of an alternative embodiment of the disclosure.

FIG. 4 is a top isometric view of an alternative embodiment of the disclosure.

FIG. 5 is a is a top view of an alternative embodiment of the disclosure.

FIG. 6 is an in-use view of an embodiment of the disclosure.

FIG. 7 is an in-use view of an embodiment of the disclosure.

FIG. 8 is a side in-use view of an embodiment of the disclosure.

### DETAILED DESCRIPTION OF THE INVENTION

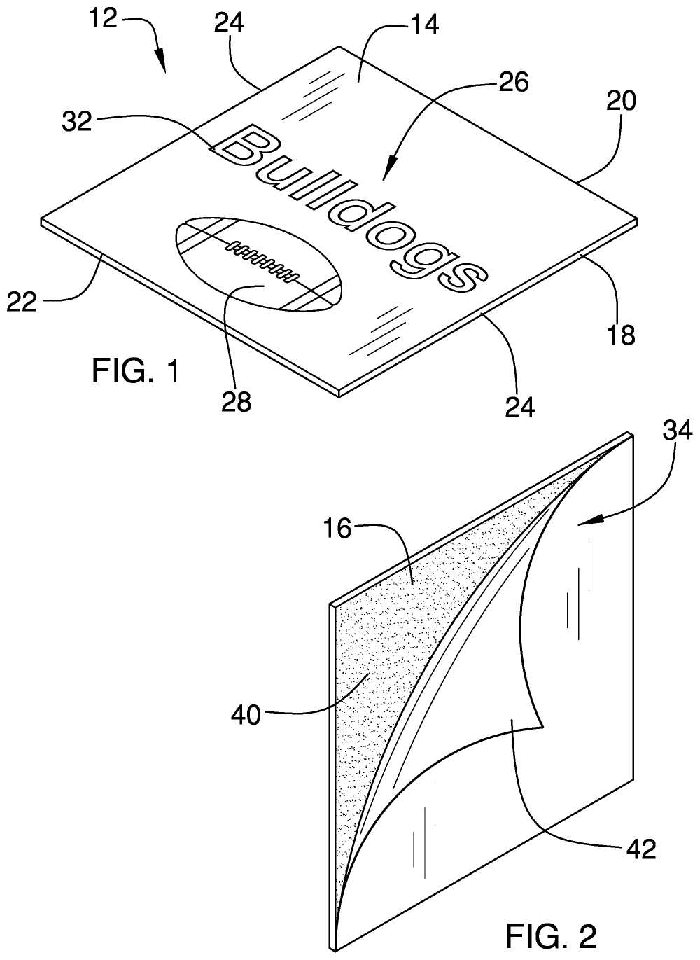

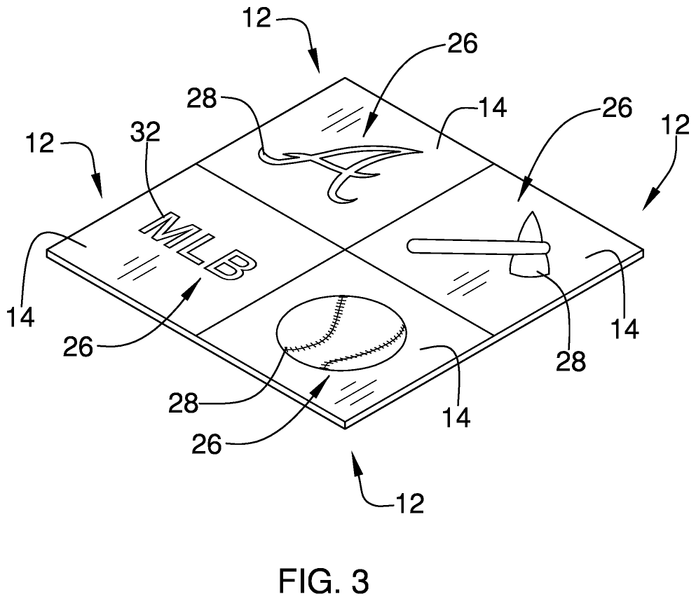

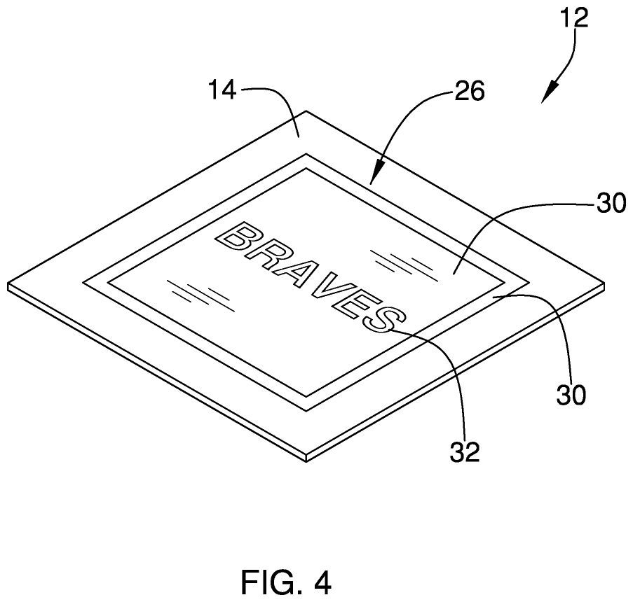

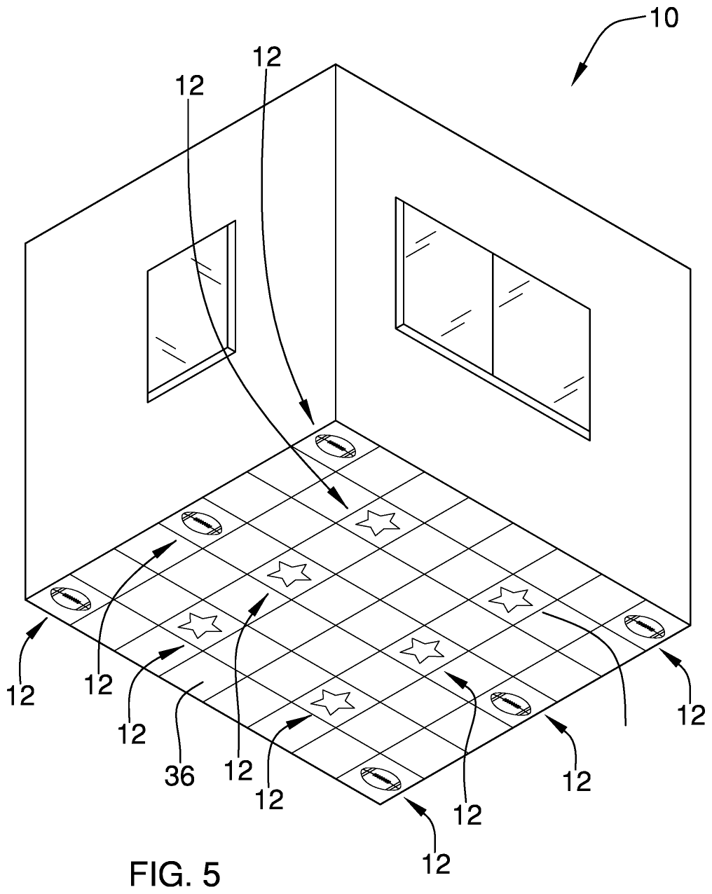

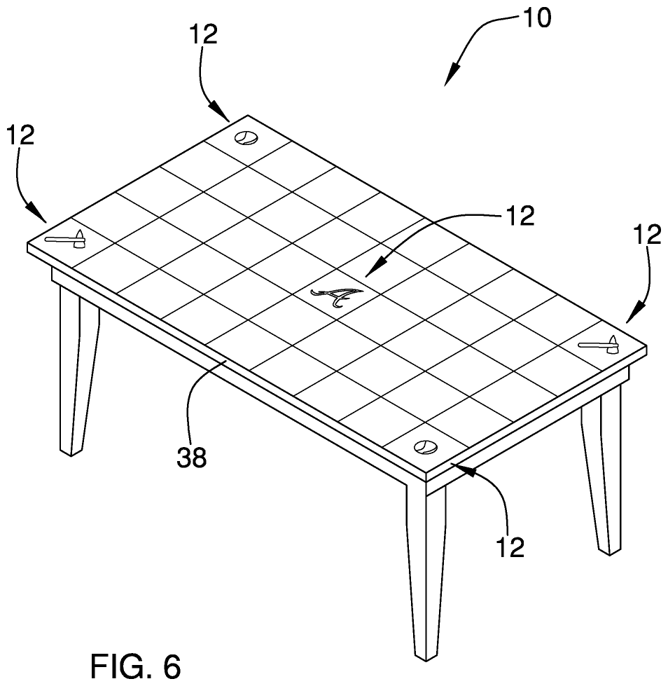

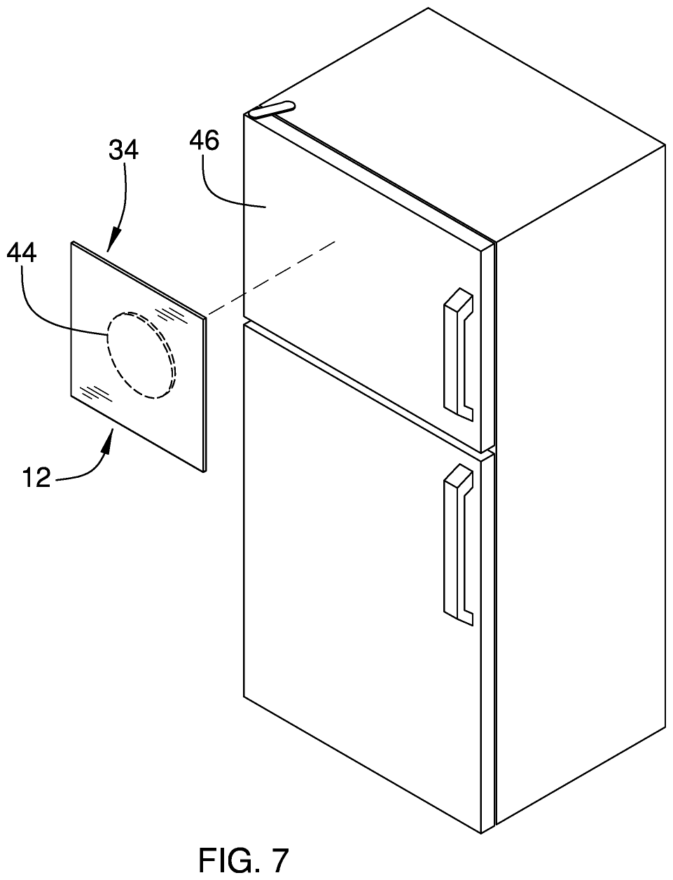

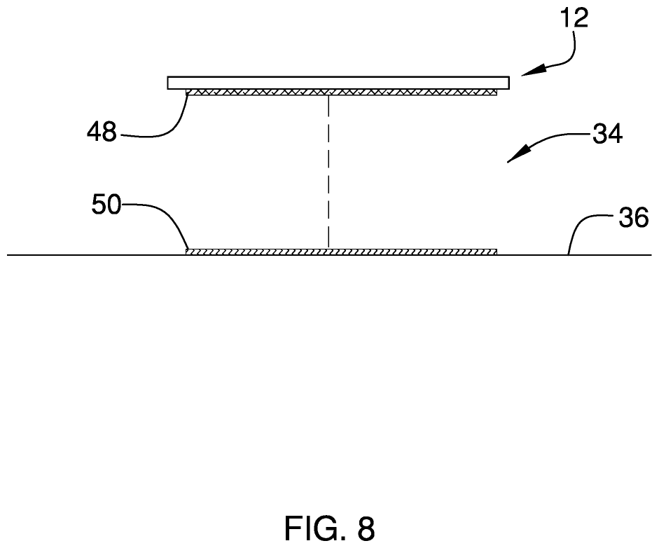

With reference now to the drawings, and in particular to FIGS. 1 through 8 thereof, a new decorative tile embodying the principles and concepts of an embodiment of the disclosure and generally designated by the reference numeral 10 will be described.

As best illustrated in FIGS. 1 through 8, the surface decoration device and method 10 generally comprises a tile 12 including a top surface 14, a bottom surface 16, and a perimeter edge 18. The perimeter edge 18 typically includes a first edge 20, a second edge 22, and a pair of lateral edges 24. The first edge 20 and the second edge 22 are parallel to each other, and the first edge 20 is perpendicular to each of the lateral edges 24. The perimeter edge 18 is normally square shaped or rectangular shaped.

A sports related indicia 26 is positioned on the top surface 14 of the tile 12 and is configured for displaying indicia corresponding to a sports team such as a hockey team, a baseball team, a football team, a basketball team, or any other sports team. The sports related indicia 26 may include an emblem 28 corresponding to the sports team such as a football for a football team, a hockey puck or hockey stick for a hockey team, a basketball for a basketball team, or a baseball and baseball bat for a baseball team. Alternatively, the emblem 28 may be a logo of the sports team. The sports related indicia 26 may also include at least one color corresponding to the sports team. The sports related indicia 26 may typically have a pair of colors 30 corresponding to the sports team, wherein the top surface 14 of the tile 12 may be colored with each of the pair of colors 30. The sports related indicia 26 may include a name 32 of the sports team or the name 32 of the sport of the sports team. Alternatively, the name 32 may be a last name of a player for the sports team.

A fastener 34 is mounted to the tile 12 and is configured to fasten the tile 12 to a floor surface 36. The fastener 34 may also be configured to fasten to an accommodatable surface 38 such as a table surface, a wall surface, a door surface, or any other accommodatable surface 38 for receiving the tile 12. The fastener 34 will normally comprise an adhesive layer 40 attached to the bottom surface 16 of the tile 12. The adhesive layer 40 may be a pressure sensitive adhesive, wherein a user may apply pressure downwardly on the top surface 14 of the tile 12 to adhere the bottom surface 16 of the tile 12 to the floor surface 36. The adhesive layer 40 has a boundary edge typically flush with the perimeter edge 18 of the tile 12 such that the adhesive layer 40 covers an entirety of the bottom surface 16 of the tile 12.

Furthermore, the fastener 34 may include a removable panel 42 positioned on the adhesive layer 40 of the bottom surface 16 of the tile 12. The removable panel 42 may have an anti-adhesive coating positioned thereon to facilitate removing the removable panel 42 from the adhesive layer 40. The removable panel 42 would prevent the adhesive layer 40 from accidentally fastening the tile 12 to unintentional surfaces. The removable panel 42 will typically comprise a flexible material such as paper or plastic. The removable panel 42 may also be disposable after being removed from the adhesive layer 40.

Alternatively, the fastener 34 may comprise another conventional fastener such as a magnetic plate 44 mounted to the bottom surface 16 of the tile 12, wherein the magnetic plate 44 may mount to magnetically engageable surfaces such as a refrigerator door 46. Another conventional fastener may also be a hook and loop fastener including a hook material 48 and a loop material 50 being removably attachable to each other. The hook material 48 may be positioned on the bottom surface 16 of the tile 12 and the loop material 50 may be positioned on the floor surface 36, wherein the tile 12 may be removably attachable to the floor surface 36.

In use, the removable panel 42 is removed from the adhesive layer 40 of the bottom surface 16 of the tile 12 and the tile 12 is fastened to the floor surface 36 by pressing down on the top surface 14 of the tile 12 onto the floor surface 36. Multiple tiles may be placed conterminous to each other until an entirety of the floor surface 36 is covered. Alternatively, the tile 12 may be mounted to the accommodatable surface 38 such as the table surface.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A surface decoration device comprising:
a tile including a top surface, a bottom surface, and a perimeter edge;
a sports related indicia being positioned on said top surface of said tile, said sports related indicia being configured for displaying indicia corresponding to a sports team; and
a fastener being mounted to said tile, said fastener being configured to fasten said tile to a floor surface.

2. The surface decoration device of claim 1, wherein said perimeter edge includes a first edge, a second edge, and a pair of lateral edges, said first edge and said second edge being parallel to each other, said first edge being perpendicular to each of said lateral edges, said perimeter edge being square shaped.

3. The surface decoration device of claim 1, wherein said sports related indicia includes an emblem corresponding to the sports team.

4. The surface decoration device of claim 3, further including at least one color corresponding to the sports team.

5. The surface decoration device of claim 3, further including a name of the sports team.

6. The surface decoration device of claim 2, wherein said fastener comprising an adhesive layer being attached to said bottom surface of said tile, said adhesive layer comprising a pressure sensitive adhesive, said adhesive layer having a boundary edge being flush with said perimeter edge of said tile.

7. The surface decoration device of claim 1, further including a removable panel, said removable panel being positioned on said adhesive layer of said bottom surface of said tile, said removable panel having an anti-adhesive coating positioned thereon to facilitate removing the removable panel from the adhesive layer.

8. A surface decoration device comprising:
a tile including a top surface, a bottom surface, and a perimeter edge, said perimeter edge including a first edge, a second edge, and a pair of lateral edges, said first edge and said second edge being parallel to each other, said first edge being perpendicular to each of said lateral edges, said perimeter edge being square shaped;
a sports related indicia being positioned on said top surface of said tile, said sports related indicia being configured for displaying indicia corresponding to a sports team, said sports related indicia including an emblem corresponding to the sports team, at least one color corresponding to the sports team, and a name of the sports team;
a fastener being mounted to said tile, said fastener being configured to fasten said tile to a floor surface, said fastener comprising an adhesive layer being attached to said bottom surface of said tile, said adhesive layer being a pressure sensitive adhesive, said adhesive layer having a boundary edge being flush with said perimeter edge of said tile; and
a removable panel, said removable panel being positioned on said adhesive layer of said bottom surface of said tile, said removable panel having an anti-adhesive coating positioned thereon to facilitate removing the removable panel from the adhesive layer.

9. A method for decorating a surface comprising the steps of:
providing a tile having a sports related indicia thereon, said tile including a top surface, a bottom surface, and a perimeter edge, said sports related indicia being positioned on said top surface of said tile, said sports related indicia being configured for displaying indicia corresponding to a sports team;
removing a removable panel from an adhesive layer of a bottom surface of said tile; and
fastening said tile to a surface.
